(19) United States
(12) Patent Application Publication
(10) Pub. No.: US 2009/0181353 A1
(43) Pub. Date: Jul. 16, 2009

(54) INTERACTIVE LEARNING

(75) Inventor: Mousumi Dasgupta, Irving, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES INC., Temple Terrace, FL (US)

(21) Appl. No.: 12/013,849

(22) Filed: Jan. 14, 2008

(51) Int. Cl. G09B 3/00

(52) U.S. Cl. 434/350

(57) ABSTRACT

A method may include selecting, by a computer, one or more students for receiving a quiz question; identifying, by a computer, test scores stored in a database and associated with the one or more students; selecting, by the computer, a quiz question from a plurality of quiz questions based on the identified test scores; sending the selected quiz question through the network to the one or more students; receiving, through the network, an answer to the quiz question from the one or more students; and adding points, after receiving the answer from the one or more student, to an account associated with the one or more students.

### BACKGROUND INFORMATION

On average, students in the United States spend four hours each day watching television. Even if students were to watch educational television during this time, which they probably would not, the students would still be passively watching—not the ideal educational setting.

### BRIEF DESCRIPTION OF THE DRAWINGS

FIG. 1 shows an exemplary environment in which embodiments described herein may be implemented;

FIG. 2 is a block diagram of exemplary components of a computing module;

FIG. 3 is a block diagram of an exemplary quiz table;

FIG. 4 is a block diagram of an exemplary user table;

FIG. 5 is a block diagram of an exemplary achievement table;

FIG. 6 is a diagram of an exemplary remote control;

FIG. 7 is a flowchart of an exemplary process for creating quiz questions, quizzes, and/or assignments;

FIG. 8 is a block diagram of an exemplary graphical user interface (GUI) for displaying an exemplary quiz question;

FIG. 9 is a block diagram of an exemplary environment for providing an exemplary interactive quiz show;

FIG. 10 is a flowchart of an exemplary process for administering an interactive quiz game show;

FIG. 11 is a block diagram of an exemplary GUI for displaying the exemplary interactive quiz show of FIGS. 9 and 10;

FIG. 12 is a block diagram of an exemplary GUI associated with selection of the quiz show of FIGS. 9 and 10;

FIG. 13 is a block diagram of a GUI associated with an exemplary student profile; and

FIG. 14 is a block diagram of an alternative exemplary environment in which systems and methods described herein may be implemented.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Interactive learning may be a better learning environment for students when compared to passive television viewing or other non-learning activities. In one or more embodiments described herein, students may communicate and collaborate with their teachers, peers, and parents in a learning environment.

One or more embodiments disclosed herein may allow for students to participate in an interactive quiz show individually or as part of a team. In one embodiment, points may be added to an account associated with a student, team, or school when the student or team accurately completes a quiz question. In one embodiment, students may be physically present in a studio during an interactive quiz show. In another embodiment, students may participate remotely with the students in the studio during the interactive quiz show.

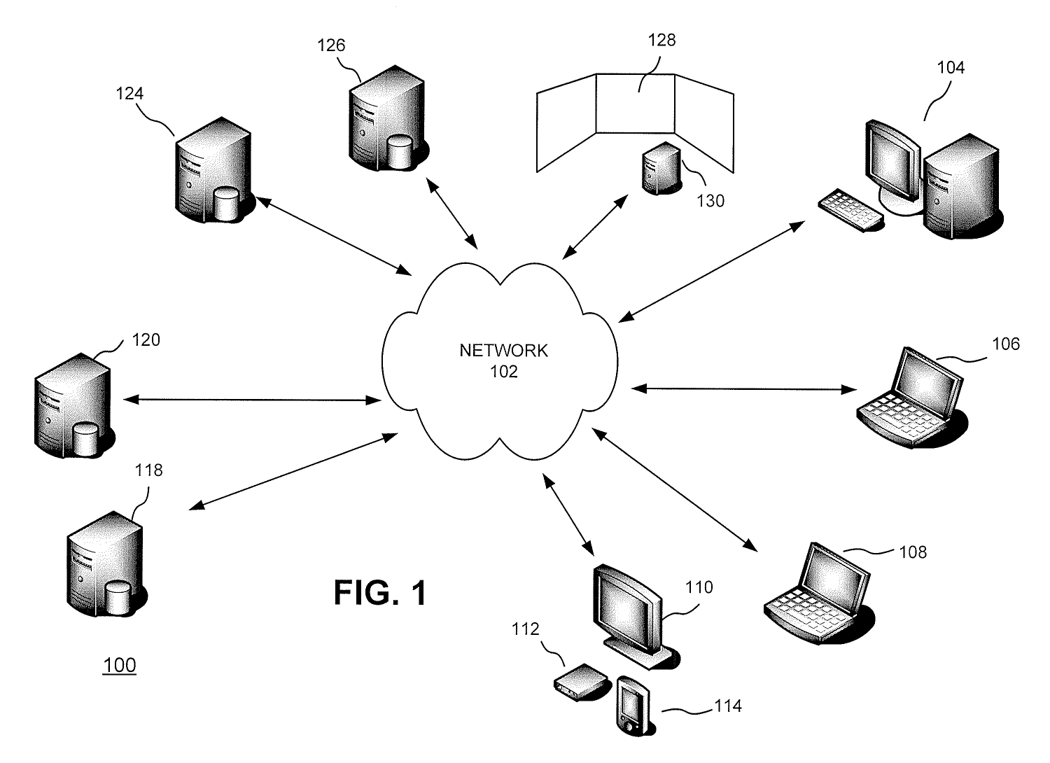

FIG. 1 shows an exemplary interactive educational environment 100 (environment 100 or interactive environment 100) in which embodiments described herein may be implemented. As shown, environment 100 may include a network 102 communicating with a group of devices 104-130. These devices may include, among other things, a classroom computer 104, a student computer 106, a parent computer 108, a television 110 (TV 110), a set-top-box 112 (STB 112), a remote control 114 (remote 114), a quiz database 118, an application and web server 120, a profile database 124, a materials database 126, a studio 128, and a studio server 130.

In other embodiments, environment 100 may include more, fewer, or different devices. For example, environment 100 may include printers for printing documents on paper. As another example, environment 100 may include more than one student computer, more than one parent computer, more than one classroom computer, etc. Moreover, one or more devices 104-130 may perform one or more functions of any other device of personal network 100. Furthermore, one or more of devices 104-130 may be remotely located from each other. Although FIG. 1 shows devices 104-130 coupled to network 102, devices 104-130 may also be coupled with each other and/or may be able to communicate directly with each other. For example, parent computer 108 may be directly coupled to student computer 106, without traversing network 102.

Besides the devices shown in FIG. 1, devices coupled to network 102 may include any computational device, including among other things: a camcorder, a personal computer; a telephone, such as a radio telephone; a personal communications system (PCS) terminal that may combine a cellular radiotelephone with data processing, facsimile, and/or data communications capabilities; an electronic note pad; a personal music player (PMP); a personal digital assistant (PDA) that may provide Internet/intranet access, web browser, organizer, calendar, and a global positioning system (GPS).

Network 102 may include the Internet, an ad hoc network, a local area network (LAN), a wide area network (WAN), a metropolitan area network (MAN), a cellular network, a public switched telephone network (PSTN), or any other network or combinations of networks. Network 102 may include a high-speed fiber optic network, such as Verizon's FiOS™ network. A fiber-optic network may provide for a high-speed link from network 102 to devices coupled to network 102, e.g., STB 112, and a high-speed link from devices coupled to network 102, e.g., STB 112, to network 102. In one embodiment, the link from network 102 to devices coupled to network 102, e.g., STB 112, may be symmetric or near symmetric, allowing for data rates to be the same or near the same, e.g., high speed, from network 102 to devices coupled to network 102 and vice versa. Network 102 may include a video signaling and distribution network to distribute the information from a content delivery system.

Classroom computer 104 (computer 104) may include one or more computer systems for hosting programs, databases, and/or applications. Computer 104 may include a laptop or any computing device, e.g., a PDA, PMP, mobile phone, etc. Computer 104 may be located in a school classroom and may be accessible by a teacher and/or student, for example. A teacher may use computer 104, for example, to create quizzes, homework assignments, or course materials for students. The teacher may use computer 104 to download educational materials from materials database 126 for incorporation into quizzes, assignments, or course materials. The teacher may use computer 104 to send quizzes, assignments, or other course materials to students (or otherwise make them available to students, such as by posting the materials to quiz database 118 or accessible storage medium). The teacher may use computer 104 to receive completed quizzes or assignments from students. Assignments, quizzes, and other course material, for example, may include Portable Document Format (PDF) documents, word processing documents, video files, audio files, text files, etc. The teacher may use computer 104 to grade student assignments or quizzes and may access student profiles in profile database 124. The teacher may use computer 104 to communicate with students (via email or messaging (e.g., text message and/or instant messaging)) and/or communicate with parents. Computer 104 may be used in the classroom to present course materials to students in the classroom.

Student computer 106 (computer 106) may include one or more computer systems for hosting programs, databases, and/or applications. Computer 106 may include a laptop or any computing device, e.g., a PDA, PMP, mobile phone, etc. Computer 106 may be used by a student in the student's home or in the student's classroom, for example. Computer 106 may include a media manager application program for storing, organizing, and playing digital media. For example, the media manager may stream music stored on computer 106 to TV 110. The media manager may send digital photographs stored on student computer 106 for display on TV 110 or parent computer 108. The media manager may create play lists of digital media and slide shows of photographs. The media manager may download digital media content from, for example, television broadcasts, the Internet, and/or a home network.

Computer 106 may include a browser application program for navigating the Internet and/or World-Wide Web (WWW). A student may use student computer 106 to receive assignments in any suitable formate, including PDF (portable document format) documents, word processing documents, video files, music files, text files, etc. A student may use computer 106 to communicate with (via email or messaging) other students, parents, and/or teachers. Computer 106 may be used to watch live classroom sessions. Computer 106 may be used to take interactive quizzes and complete assignments or participate in an online, interactive quiz show.

Parent computer 108 (computer 108) may include one or more computer systems for hosting programs, databases, and/or applications. Computer 108 may include a laptop or any computing device, e.g., a PDA, PMP, mobile phone, etc. Using computer 108, the parent may access a student's profile (e.g., a child's profile) stored in profile database 124. Using computer 108, the parent may email or message a student or the student's teacher. Using computer 108, the parent may request help, e.g., academic coaching or tutoring, for a student in need. Using computer 108, the parent may manage a student's account, e.g., configure who can access profile information, etc. Using computer 108, the parent may also view the student's curriculum, course profiles, course assignments, communications, etc. Using computer 108, the parent may view a student's progress as reported by teachers or view developmental graphs, recommended courses, or self help materials that may be downloaded and/or purchased in form of video-on-demand (VOD) content or interactive content.

TV 110 may include a device capable of receiving and reproducing video and audio signals, e.g., a video display device. TV 110 may include a liquid crystal display (LCD), a cathode ray tube (CRT), a plasma display, etc. TV 110 may be associated with one or more speakers that output audio signals, such as stereo or mono audio. In another embodiment, TV 110 may include a computer monitor, a display of a stationary communication device (e.g., a telephone), or a portable communication device (e.g., a mobile telephone or a PDA), or the like. TV 110 may perform the same functions as student computer 106 and/or parent computer 108.

TV 110 may be associated with STB 112. STB 112 may include one or more computer systems for hosting programs, databases, and/or applications. STB 112 may receive communications from a cable and/or network service provider and may output video signals for display on TV 110. STB 112 may send communications to a cable and/or network service provider, e.g., requests for content for display. STB 112 may be used to order and receive VOD content from a content provider.

In another embodiment, STB 112 may include a computer device, a cable card, a stationary communication device (e.g., a telephone), a portable communication device (e.g., a mobile telephone or a personal digital assistant (PDA)), or the like. STB 112 may perform decoding and/or decryption functions on information received from a content delivery system. STB 112 may include a video client.

TV 110 may be associated with remote 114. Remote 114 may include control keys to navigate menus displayed on TV 110, for example, and to otherwise control functions of TV 110 and/or STB 112. Remote control 114 may transmit infrared signals, or another type of signals, to a reader associated with STB 112 and/or TV 110.

Quiz database 118 may store course curricula, e.g., topics and subjects that a teacher may be required to teach. Quiz database 118 may also store a teacher's course profile, e.g., a teacher's teaching plan including assignments with material copied from materials database 126 or referred to as being stored in materials database 126. Quiz database 118 may also store assignments and quizzes prepared by the teacher for class. Quiz database 118 may also store quiz questions and quizzes prepared by the teacher for an interactive quiz show.

Application and web server 120 (server 120) may include one or more computer systems for hosting programs, databases, and/or applications. Server 120 may run a web server application, such as Apache, to serve web pages when requested. Server 120 may serve pages including information from profile database 124, materials database 126, or quiz database 118. For example, if the parent uses a web browser in computer 108 to access a student's profile, the request may be sent to server 120, which may request the information from profile database 124. Server 120 may then serve the information to computer 108 for viewing by the parent.

Server 120 may allow for messaging between student, teachers, and/or parents. Messaging between students, teachers, and/or parents may include “white boarding,” e.g., the interactive free-hand writing collaboration between students, teachers, and/or parents. Server 120 may allow for the viewing of live classes or quiz shows from a classroom or from studio 128. Server 120 may allow for other forms of collaboration between students, teachers, and parents, including Voice over Internet Protocol (VoIP) or video conferencing, for example. Server 120 may include an application to help a teacher to use classroom computer 104 to develop course profiles or quizzes. Server 120 may automatically score quiz questions or quizzes taken by students during, for example, a quiz show. Server 120 may evaluate student performance, e.g., a student's scores, and may recommend an interactive study course to improve student performance. Server 120 may evaluate student performance and may recommend a quiz or quiz question for an interactive quiz show.

Profile database 124 may store profiles associated with students, teams of students, or schools. A student profile may include quizzes, assignments, quiz scores, assignment scores, the identity of individuals privileged to access the profile, etc. A student profile may include an indication of the school the student attends. A student profile may include the grade (e.g., scores) the student has achieved in each class and the number of points the student has earned for completing quizzes and assignments. A team profile may include quizzes, assignments, quiz scores, and assignment scores of teams of students. For example, a chemistry class team may have its own profile. A team profile may also include the points earned by the team for completing quizzes and assignments. A school's profile may include quizzes, assignments, quiz scores, and assignment scores of schools. A school profile may also include the points earned by the school for completing quizzes and assignments.

Materials database 126 may include a library of instructional resources. The instructional resources may be categorized and organized and may be searched by, for example, teachers, students, or parents. Videos across numerous topics may be stored in materials database 126 and may simplify difficult topics to increase learning retention. Materials database 126 may include recorded classes, VOD, course profiles, projects, worksheets, quizzes, glossaries, encyclopedias, dictionaries, etc. The teacher may upload course profiles, assignments, and quizzes that the teacher created to materials database 126 for sharing with other teachers.

Studio 128 may include a recording studio (including one or more microphones and/or video cameras), a stage, an amphitheater, etc. Studio 128 may be located in a school or in the offices of a major broadcasting network, for example. Studio 128 may allow for conferences, plays, game shows, television shows, etc. Studio 128 may include studio server 130 that may broadcast events taking place in studio 128.

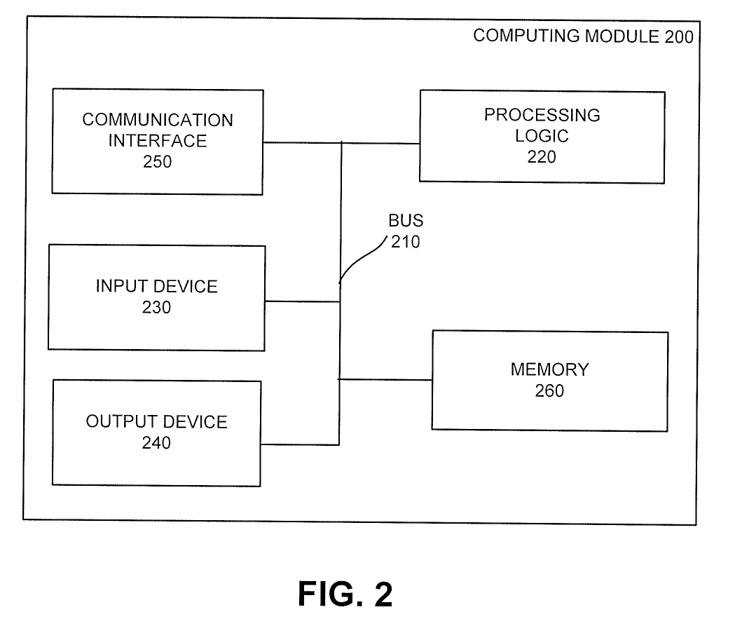

FIG. 2 is a block diagram of exemplary components of a computing module 200 (module 200). Any one of devices 104-130 may include one or more computing modules (e.g., a rack of computer modules), such as computing module 200. Module 200 may include a bus 210, processing logic 220, an input device 230, an output device 240, a communication interface 250, and a memory 260. Module 200 may include other components (not shown) that aid in receiving, transmitting, and/or processing data. Moreover, other configurations of components in device 200 are possible. Further, one or more components of module 200 may be remotely located.

Bus 210 may include a path that permits communication among the components of module 200. Processing logic 220 may include any type of processor or microprocessor (or groups of processors or microprocessors) that interprets and executes instructions. In other embodiments, processing logic 220 may include an application-specific integrated circuit (ASIC), a field-programmable gate array (FPGA), or the like.

Input device 230 may include a device that permits a user to input information into module 200, such as a keyboard, a keypad, a mouse, a pen, a microphone, a remote control, a touch-screen display, one or more biometric mechanisms, or the like. Output device 240 may include a device that outputs information to the user, such as a display, a printer, a speaker, etc. Output device 240 may include a vibrator to alert a user.

Input device 230 and output device 240 may allow the user of module 200 to receive or view a menu of options. The menu may allow the user to select various functions or services associated with applications executed by module 200 or other devices coupled to network 102. Input device 230 and output device 240 may allow the user to activate a particular service or application, such as a service defined by a device table described below.

Communication interface 250 may include any transceiver-like mechanism that enables module 200 to communicate with other devices and/or systems. Communication interface 250 may include a transmitter that may convert baseband signals from processing logic 220 to radio frequency (RF) signals and/or a receiver that may convert RF signals to baseband signals. Alternatively, communication interface 250 may include a transceiver to perform functions of both a transmitter and a receiver. Communication interface 250 may be coupled to an antenna for transmission and reception of the RF signals. Communications interface 250 may include a network interface card, e.g., Ethernet card, for wired communications or a wireless network interface (e.g., WiFi) card for wireless communications. Communication interface 250 may also include, for example, a universal serial bus (USB) port for communications over a cable, a Bluetooth™ wireless interface for communicating with other Bluetooth™ devices, a near-field communication (NFC) device, etc. Communications interface 250 may receive, transmit and/or process digital or analog audio inputs/outputs and/or digital or analog video inputs/outputs.

Memory 260 may include a random access memory (RAM) or another type of dynamic storage device that may store information and instructions, e.g., an application, for execution by processing logic 220; a read-only memory (ROM) device or another type of static storage device that may store static information and instructions for use by processing logic 220; and/or some other type of magnetic or optical recording medium and its corresponding drive, e.g., a hard disk drive (HDD), for storing information and/or instructions.

Computing module 200 may perform certain operations, as described in detail below. Computing module 200 may perform these operations in response to processing logic 220 executing software instructions contained in a computer-readable medium, such as memory 260. A computer-readable medium may be defined as a physical or logical memory device. The software instructions may be read into memory 260 from another computer-readable medium or from another device via communication interface 250. The software instructions contained in memory 260 may cause processing logic 220 to perform processes that are described below.

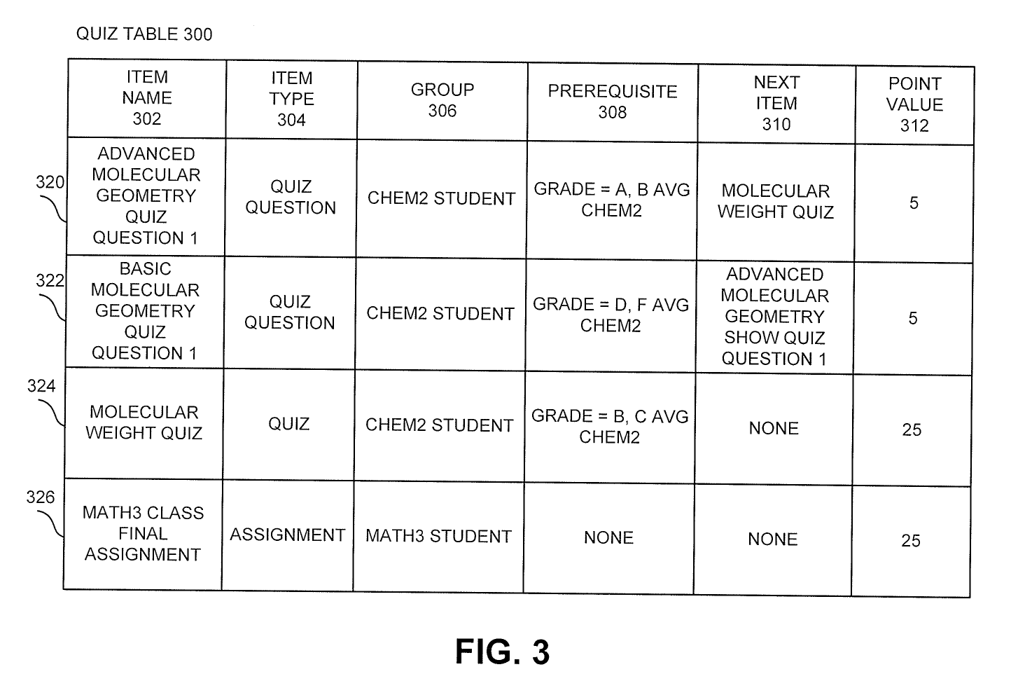

FIG. 3 is a block diagram of an exemplary quiz table 300. Quiz table 300 may store a number of records corresponding to the quiz questions, quizzes, assignments, and course profiles (e.g., items) stored in interactive environment 100. Quiz table 300 may also store or maintain characteristics of the stored items. For example, quiz table 300 may also store a point value associated with the item. Quiz table 300 may be stored in memory 260 of quiz database 118, for example, or any device coupled to network 102. In another embodiment, quiz table 300 may be stored in memory 260 of profile database 124 or in memory 260 of materials database 126, for example. Records in quiz table 300 may include an item name field 302, an item type field 304, a group field 306, a prerequisite field 308, a next item field 310, and a point value field 312. These fields are exemplary and quiz table 300 may include additional, different, or fewer fields than illustrated in FIG. 3. A number of records (e.g., records 320-326) may include values for some or all of fields 302-312.

Item name field 302 may include the name of the item (e.g., quiz question, quiz, assignment, etc.) created by a teacher, for example. The name may be descriptive of the item, such as ADVANCED MOLECULAR GEOMETRY QUIZ QUESTION 1 as shown in record 320 of FIG. 3. Item names other than what is shown in FIG. 3 are possible.

Item type field 304 may include the type of item associated with the record, and may include types such as QUIZ, QUIZ QUESTION, ASSIGNMENT, or COURSE PROFILE, for example. Item types other than those shown in FIG. 3 are possible. As shown in record 320, the item with the name ADVANCED MOLECULAR GEOMETRY QUIZ QUESTION 1 may have the type QUIZ QUESTION shown in item type field 304. As shown in record 322, the item with the name BASIC MOECULAR GEOMETRY QUIZ QUESTION 1 may also have the type QUIZ QUESTION shown in type field 304. As shown in record 324, the item with the name MOLECULAR WEIGHT QUIZ may have the type QUIZ (e.g., indicating more than one question). As shown in record 326, the item with the name MATH3 CLASS FINAL ASSIGNMENT may have the item type of ASSIGNMENT.

Group field 306 may include the groups of people allowed to access, take, be quizzed by, etc., the corresponding item. In other words, group field 306 may also indicate one or more groups for whom the corresponding quiz question, quiz, or assignment was intended. For example, the item associated with record 320 may be accessed by CHEM2 STUDENT (e.g., a student taking Chemistry 2 class). A group defined in field 306 may be very general (e.g., STUDENT) or very specific (e.g., BRANDON LEE). Group types may also be expressed by an equation and may be conditional. In one embodiment, an item may be limited to a single individual who has achieved a particular achievement level in a specific class (e.g., BRANDON LEE CHEM2 AVERAGE>90). Other exemplary groups not shown in FIG. 3 for controlling access to items may include CHEM2 PARENT (e.g., a parent of a student taking Chemistry 2 class), and ADMIN (e.g., any school or district administrator).

Prerequisite field 308 may include the prerequisites, e.g., conditions such as an achievement level, etc., for taking or viewing the associated item. For example, the quiz associated with record 320 may only be taken or viewed by students with a B average or higher (e.g., IF GRADE=A or B) in Chemistry 2 class. In another example, a basic quiz may be associated with students who have a “D” science average. In exemplary quiz table 300, the quiz associated with record 322 may only be taken or viewed by students with an F or D average (e.g., IF GRADE=D or F) in Chemistry 2 class.

Next item field 310 may include one or more names of items recommended that a student may complete next after completing the item associated with the current record. For example, after completing the ADVANCED MOLECULAR GEOMETY QUIZ QUESTION 1, the student may be referred to the MOLECULAR WEIGHT QUIZ, as indicated in field 310 of record 320 of quiz table 300. After completing the BASIC MOLECULAR GEOMETRY QUIZ QUESTION 1, the student may be referred to ADVANCED MOLECULAR GEOMETRY QUIZ QUESTION 1 of record 320, for example, as indicated in record 322.

Point value field 312 may include a number of points associated with the particular quiz or assignment. For example, completing MOLECULAR WEIGHT ASSIGNMET may be given a point value of 25 points (record 324) by the teacher who created that particular assignment. Completing BASIC MOLECULAR GEOMETYR QUIZ QUESTION 1 may be given a point value of 5 points (recored 322) by the teacher who created that particular quiz. Completing ADVANCED MOLECULAR GEOMETRY QUIZ QUESTION 1 may be given a point value of 5 points (record 320) by the teacher who created that particular quiz.

Other types of point values are possible for quiz table 300. For example, the point value could be broken down to particular questions, such as Q1=5, Q2=5, and Q3=5, indicating that a correct answer for the first question may be worth five points, a correct answer for the second question may be worth five point, etc. Formulas for points could be based on the date of completion, giving students an incentive to complete assignments early.

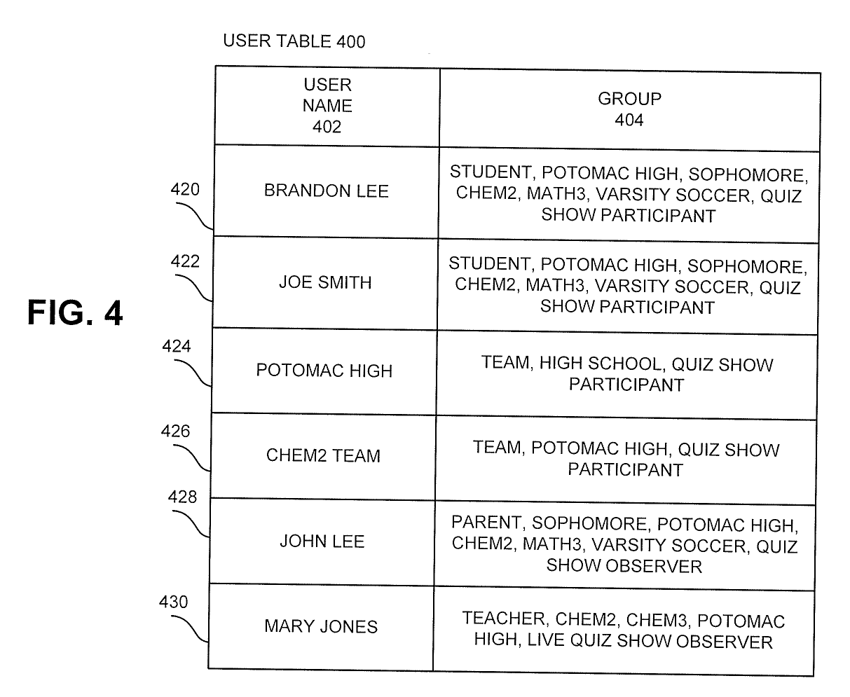

FIG. 4 is a block diagram of an exemplary user table 400. User table 400, e.g., a database, may store a list of users (including institutional users) that are allowed to access interactive environment 100, such as databases 118, 124, and 126, and application and web server 120, for example, and the groups associated with the corresponding user. User table 400 may be stored in memory 260 of any device coupled to network 102, such as databases 118, 124, or 126, or web server 120. User table 400 may include a number of records corresponding to users of environment 100. Records may include a user name field 402 and a group field 404. User table 400 may include additional, different, or fewer fields than illustrated in FIG. 4.

User name field 402 may include the name of a user or an institution that may have access to interactive environment 100. Students, teachers, parents, teams, and schools may each have a user name and a record in user table 400. In the exemplary user table 400, there are six users listed: BRANDON LEE, JOE SMITH, POTOMAC HIGH, CHEM2 TEAM, JOHN LEE, and MARY JONES. In other words, Brandon Lee, Joe Smith, the Potomac High School, the Chemistry 2 team, John Lee, and Mary Jones may be allowed some form of access to interactive environment 100.

Group field 404 may indicate the groups with which the corresponding user name in user name field 402 may be associated. In the exemplary user table 400, record 420 indicates the user name BRANDON LEE may be associated with the following groups as indicated in corresponding group field 404: STUDENT, POTOMAC HIGH, SOPHOMORE, CHEM2, MATH3, VARSITY SOCCER, and QUIZ SHOW PARTICIPANT. In other words, Brandon Lee may be a sophomore student at Potomac High who takes Chemistry 2 and Math 3 classes, is on the varsity soccer team, and may participate in quiz shows. In the exemplary user table 400, record 422 indicates the user name JOE SMITH may be associated with the following groups as indicated in corresponding group field 404: STUDENT, POTOMAC HIGH, SOPHOMORE, CHEM2, MATH3, VARSITY SOCCER, and QUIZ SHOW PARTICIPANT. In other words, Joe Smith may be a sophomore student at Potomac High who takes Chemistry 2 and Math 3 classes, is on the varsity soccer team, and may participate in quiz shows. Record 424 indicates the user name POTOMAC HIGH may be associated with the following groups: HIGH SCHOOL and QUIZ SHOW PARTICIPANT. In other words, Potomac High may be a high school that may participate in a quiz show, for example. Record 426 indicates the user name CHEM2 TEAM may be associated with the following groups: TEAM, POTOMAC HIGH, and QUIZ SHOW PARTICIPANT. In other words, the Chemistry 2 team may be a associated with Potomac High, and may participate in a quiz show as a team, for example. Record 428 indicates that a user name JOHN LEE may be associated with the following groups: PARENT, SOPHMORE, POTOMAC HIGH, CHEM2, MATH3, VARSITY SOCCER, and QUIZ SHOW OBSERVER. In other words, John Lee may be a parent of a sophomore who attends Potomac High, takes Chemistry 2, Math 3, and is on the varsity soccer team. John Lee may also be able to observe quiz shows. Record 430 indicates that a user name MARY JONES may be associated with the following groups: TEACHER, CHEM2, CHEM3, POTOMAC HIGH, and QUIZ SHOW OBSERVER. In other words, Mary Jones may be a teacher involved with Chemistry 2 and Math 3 at Potomac High. Mary Jones may also be able to observe quiz shows.

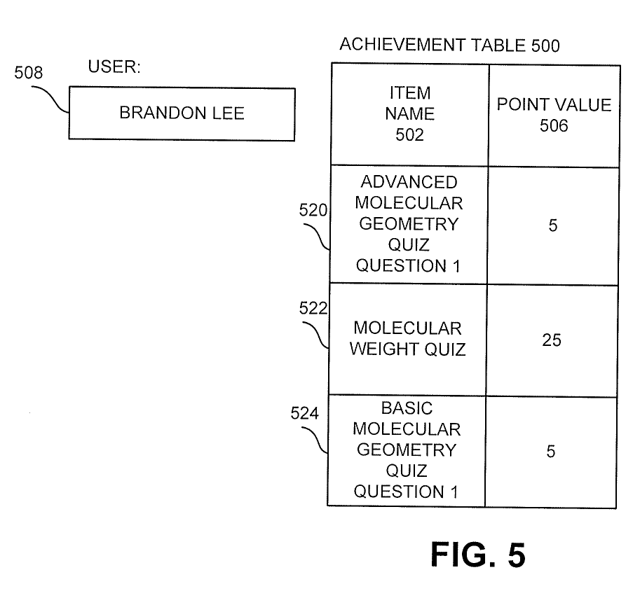

FIG. 5 is a block diagram of an exemplary achievement table 500. Achievement table 500, e.g., a database, may include a number of records corresponding to the quiz questions, quizzes, assignments, etc. completed by a user (e.g., a student, team, school, etc.), such as the completed quizzes or assignments and the corresponding grade and/or earned points. Each student, team, and school listed in user table 400 may be associated with its own achievement table 500. In one embodiment, achievement table 500 may be stored in memory 260 of profile database 124. In another embodiment, achievement table 500 may be stored in any device coupled to network 102, such as in memory 260 of web server 120 or quiz database 118. Records in achievement table 500 may include an item name field 502, a point value field 506, and a user field 508. Achievement table 500 may include additional, different, or fewer fields than illustrated in FIG. 5.

Item name field 502 may include the name of the item (e.g., quiz question, quiz, assignment, etc.) associated with the student (or team, school, etc.) listed in user field 508. Exemplary achievement table 500 may be for the student BRANDON LEE as indicated in user field 508. As indicated by item name field 502, user BRANDON LEE may have taken or completed the following quizzes, quiz questions, or assignments: ADVANCED MOLECULAR GEOMETRY QUIZ QUESTION 1, MOLECULAR WEIGHT QUIZ, and BASIC MOLECULAR GEOMETRY QUIZ.

Point value field 506 may indicate the number of points earned for the corresponding item in item name field 502. For example, user BRANDON LEE earned 5 points (record 520) for completing the ADVANCED MOLECULAR GEOMETRY QUIZ QUESTION1, 25 points (record 522) for completing the MOLECULAR WEIGHT QUIZ, and 5 points (record 524) for completing the BASIC MOLECULAR GEOMETRY QUIZ QUESTION 1.

Points earned (as indicated in field 506) may also be calculated based on a formula as indicated in point value field 312 of quiz table 300. For example, if user BRANDON LEE did not achieve a 100% score on the MOLECULAR WEIGHT QUIZ, in one embodiment, he may receive less than 25 points depending on the point equation in point value field 312 of quiz table 300, for example. Points earned (as indicated in field 506) may also correspond to test scores, grades, etc.

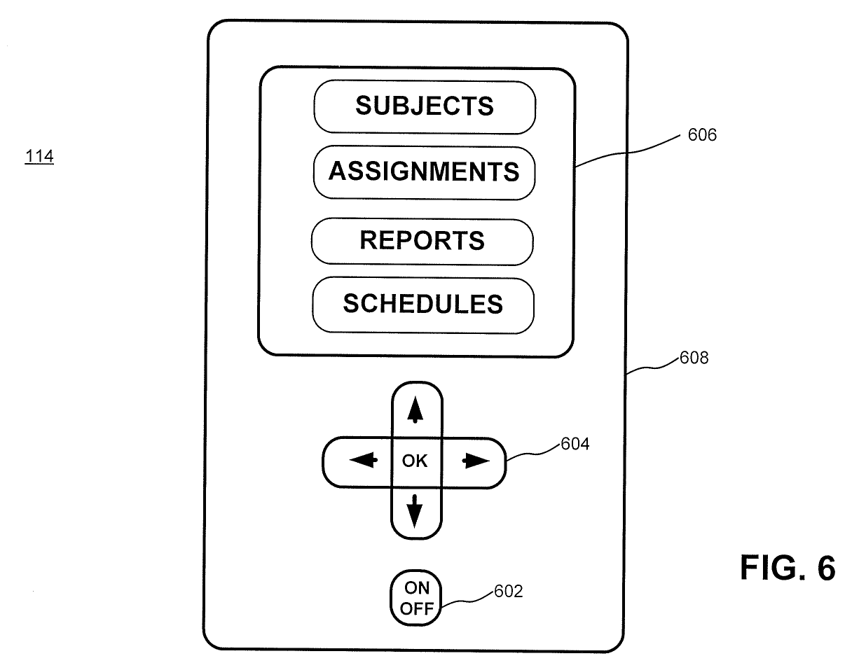

FIG. 6 is a diagram of an exemplary remote 114 of FIG. 1. Remote 114 may include an on/off button 602, control buttons 604, a display 606, and a housing 608. On/off button 602 may turn TV 110 on and off. Control buttons 604 may include left, right, up, down, and OK buttons. The user of remote 114 may interact with TV 110 to control TV 110. For example, remote control 114 may be used to navigate menus displayed on TV 110. Remote 114 may also be used to navigate menus displayed on display 606, such as navigating and selecting a SUBJECTS button, an ASSIGNMENTS button, a REPORTS button, and a SCHEDULES button. Remote control 114 may be used, for example, to input answers to quiz questions shown on TV 110 or display 606. Remote 114 may communicate with TV 110 via infra red (IR) or RF signals. In an alternative implementation, remote 114 may interact with STB 112.

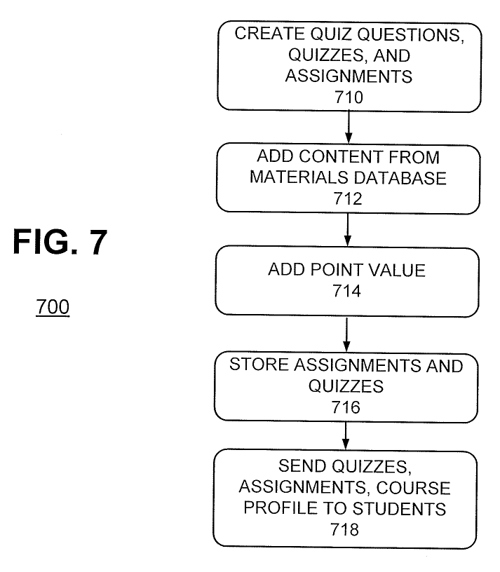

FIG. 7 is a flowchart of an exemplary process 700 for creating quiz questions, quizzes, and/or assignments and associating point values with the quiz questions, quizzes, and/or assignments. Process 700 may begin when a quiz question, quiz, or assignment is created (block 710). For example, the teacher, using classroom computer 104, may create a quiz question, quiz, or assignment for students to complete at home, in the classroom, or during a quiz show. Content may be added to the assignment or quiz from materials database 126 (block 712). The teacher may search and browse content from materials database 126 from classroom computer 104, for example, to determine what material may be best for inclusion in the quiz or assignment. A point value may be added (block 714). The teacher may determine the point value to associate with the quiz or assignment. For example, the teacher may determine that the ADVANCED MOLECULAR GEOMETRY QUIZ QUESTION 1 of record 320 in quiz table 300 may be valued at 5 points. Accordingly, the teacher may record 5 points in quiz table 300. The assignment or quiz may be stored (block 716). The teacher may store the assignment or quiz in quiz database 118 so that they are available for later retrieval. In one embodiment, quiz questions and/or quizzes are made available for retrieval during a quiz show. For example, a teacher may create the MOLECULAR WEIGHT QUIZ and save it to quiz database 118 in record 320 of quiz table 300.

Assignments, quiz questions, and quizzes may be sent to or associated with students (block 718). In one embodiment, the teacher may use classroom computer 104 to email quiz questions, quizzes, and/or assignments to students or associate quiz questions, quizzes, or assignments with users' profiles. Teachers may send assignments, quizzes, and course profiles to an entire class, to groups within a class, or to individuals, e.g., individuals in need of special attention.

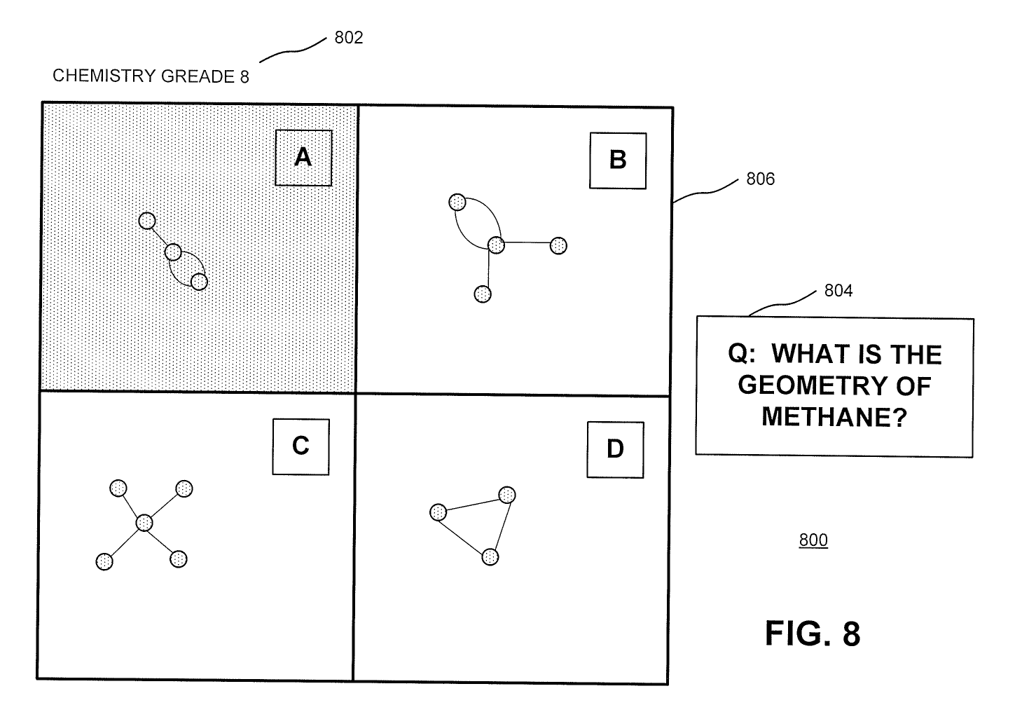

FIG. 8 is a block diagram of an exemplary graphical user interface (GUI) 800 for displaying an exemplary quiz question, such as a quiz question created using method 700. GUI 800 may include a quiz title 802, a question 804, and a multiple choice selection 806 including possible answers A, B, C, and D. The student may use control keys 604 on remote 114 to navigate to what he or she believes to be the correct answer and may select the answer by pressing the OK button. GUI 800 may be shown on display 606 of remote 114, for example, or on TV 110. A quiz or assignment may include a series of questions, such as the question on exemplary GUI 800. In one embodiment, the assignment or quiz may be informational in nature, e.g., study material, support information, or support material.

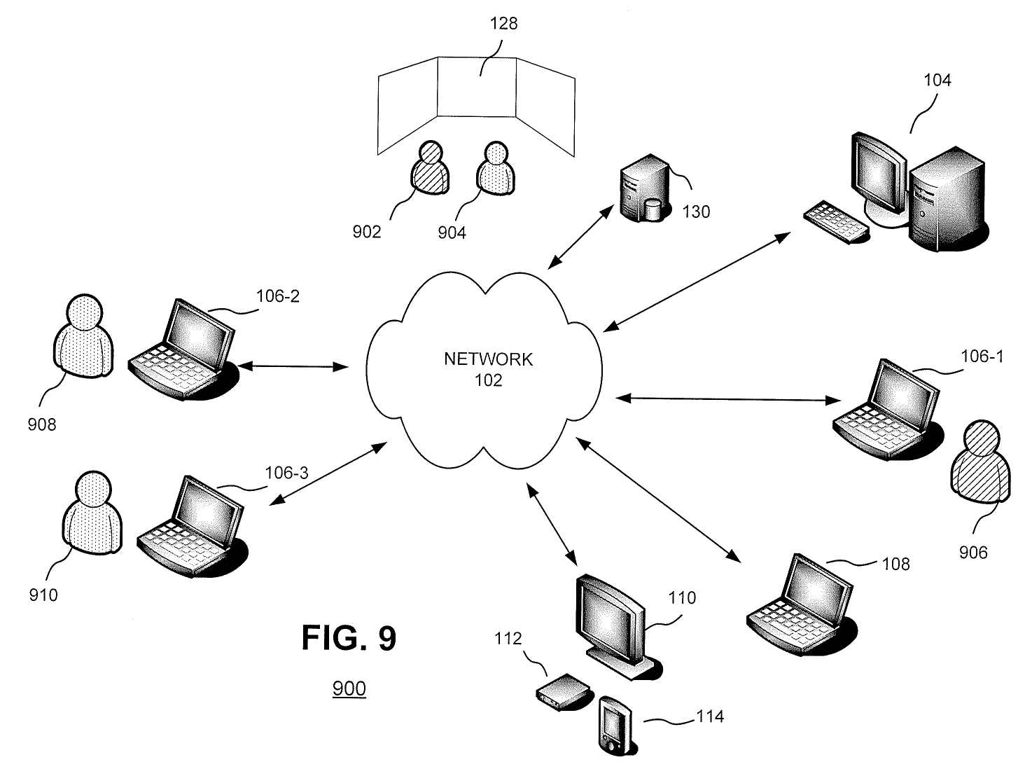

FIG. 9 is a block diagram of an environment 900 for providing an exemplary interactive quiz show. Environment 900 may include network 102, studio 128, studio server 130, TV 110, STB 112, remote 114, and student computers 106-1 through 106-3. One or more of student computers 106-1 through 106-3 may be configured similarly to student computer 106 described above. In another embodiment, one or more of student computers 106-1 through 106-3 may be configured similarly to TV 110. In this latter embodiment, one or more of student computers 106-1 through 106-3 may include remote controls and set top boxes similar to remote 114 and STB 112. In this embodiment, quiz questions may be shown on the TV (similar to TV 110) or on the display of the remote control (similar to display 606 of remote 114) and answers may be received via the remote control.

The exemplary interactive quiz show of FIG. 9 may include five students, e.g., contestants: two students 902 and 904 physically present in studio 128 and three students 906, 908, and 910 participating remotely from student computers 106-1, 106-2, and 106-3, respectively. Because one or more of students 902 through 910 may not be physically present in the same room or building (e.g., one or more may be participating from home), one or more of students 902 through 910 may be considered geographically separate or students 902 through 910 may be considered geographically diverse.

In one embodiment, students may be associated with different teams. For example, students 902 and 906 may attend the same school and may both be associated with a team for the school they both attend. As shown in FIG. 9, students 902 and 906 are striped. Contestants 904, 908, and 910 may all attend the same school (but different than contestants 902 and 906) and may be associated with a team for the school they attend. As shown in FIG. 9, students 904, 908, and 910 are dotted.

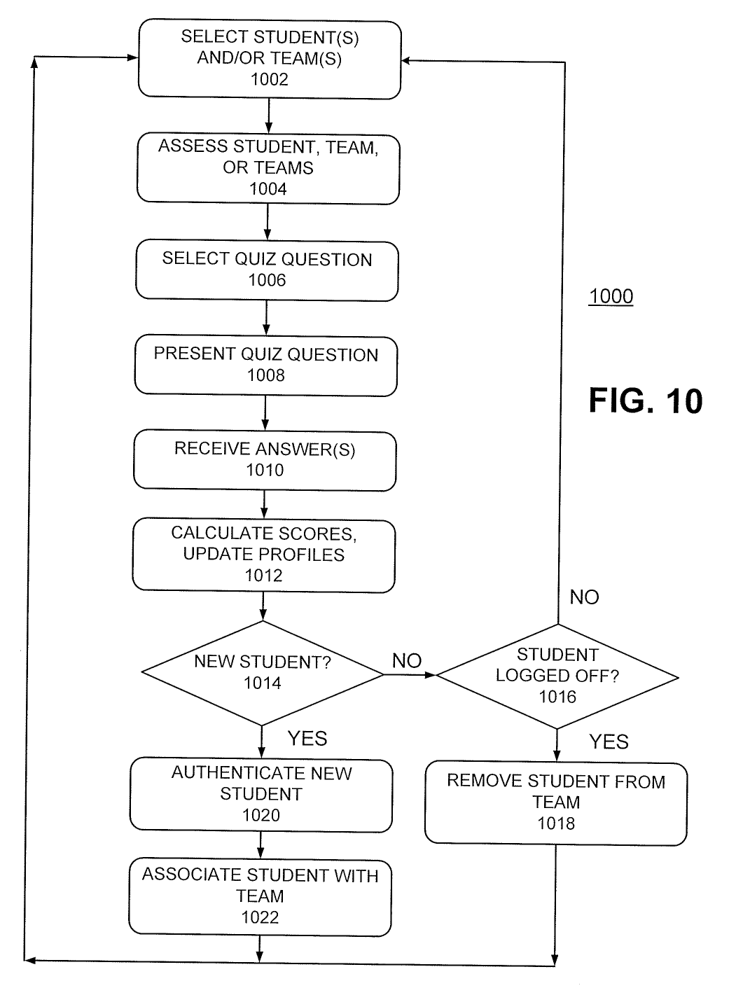

FIG. 10 is a flowchart of an exemplary process 1000 for an interactive quiz game show. Process 1000 may run in application server 120 or studio server 130, for example. In another embodiment, process 1000 may run in any device coupled to network 102. In another embodiment, the execution of process 1000 may be distributed among various devices in environment 100. Process 1000 may begin with a selection of a student, more than one student (e.g., a student from each of more than one team), a team of students, or teams of students (e.g., contestants) for receiving a quiz question (block 1002). The selected student(s) and/or team(s) may depend on the type of quiz show. For example, in one embodiment a quiz question may be posed to a single student on one team. In another embodiment, a quiz question may be posed to an entire team and any student of the team may answer the question (e.g., answer for the entire team). In yet another embodiment, a quiz question may be posed to multiple teams simultaneously for each team to answer. In another embodiment, a quiz question may be posed to a single student in each of a group of teams, where each selected student may answer the question. Teams and/or students may be selected in a round-robin fashion or randomly.

The selected student(s) and/or team(s) may be assessed (block 1004) An assessment may include determining the selected student(s) and/or team(s) grades for a particular subject. For example, process 1000 may access achievement table 500 to determine the selected student(s) and/or team(s) average in a class. An assessment may include searching quiz table 300 to determine which quiz questions, quizzes, etc., include group field 306 information and prerequisite field 308 information that are satisfied by the selected student(s) and/or team(s). One of the quiz questions, quizzes, etc. (found in block 1004) may be selected (block 1006). Interactive environment 100 may select the quiz question, quiz, etc., automatically or randomly, or in one embodiment, a student or a teacher may select the quiz question, quiz, etc.

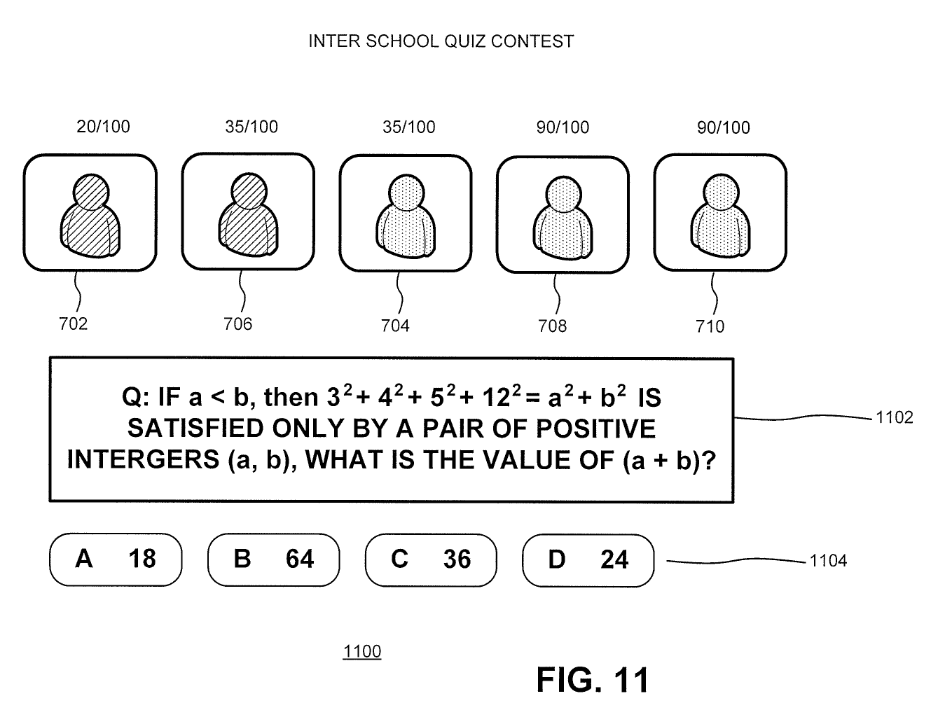

A quiz question may be presented to the selected student(s) and/or team(s) (block 1008). FIG. 11 is a block diagram of a GUI 100 for displaying the exemplary interactive quiz show. GUI 1100 may be shown on TV 110, for example, for viewing by parents, teachers, other students, or the public. GUI 1100 may also be shown on student computers 106-1 through 106-3, for example, for students 702 through 710 to interact with during the live quiz show. GUI 1100 may include pictures or live images of students 702 through 710. GUI 1100 may include a question 1102 and multiple choice answers 1104.

One or more answers may be received (block 1010). If the question (from block 1008) was presented to more than one student or more than one team, multiple answers may be received. In one embodiment, student 702 may use control keys (similar to control keys 604) on a remote control (similar to remote 114) to navigate to what he or she believes to be the correct answer and may select the answer by pressing the OK button. Answers may also be received from students 702 through 710 through a keyboard or microphone, for example.

The accuracy of the one or more answers may be determined and selected student(s) and/or team(s) profiles may be updated (block 1012). In one embodiment, quiz table 300 may store quiz questions and point values associated with each quiz question. In this embodiment, students, teams, and/or schools may be rewarded the point value stored in quiz table 300. The team and/or school rewarded points may be associated with the student(s) that accurately answered the quiz question, for example. In one embodiment, a contestant may receive a point for every correct answer. In another embodiment, the team may receive a point for every correct answer by a team member. In yet another embodiment, the school may receive a point for every correct answer by a school member. Profiles may be updated to reflect points earned for correct answers to quiz questions. In one embodiment, the team and/or the school may be associated with an achievement table that may be updated to reflect earned points.

The interactive quiz show may allow for students to join or leave the show (block 1014). If no new student wishes to join the quiz show (block 1014: NO) and no student logs off the quiz show (block 1016: NO), then process 1000 may return to block 1004 for a new question. If a new student wishes to join the quiz show (block 1014: YES), he or she may be authenticated (block 1020) and associated with a team for the quiz session (block 1022), and process 1000 may then continue to block 1002 with a selection of another one or more students or teams for presenting the next quiz question. If a student has logged off (block 1012: YES), then the student may be removed from the appropriate team for the quiz session (block 1018). Processing may then continue to block 1002 with a selection of another one or more students or teams for presenting the next quiz question.

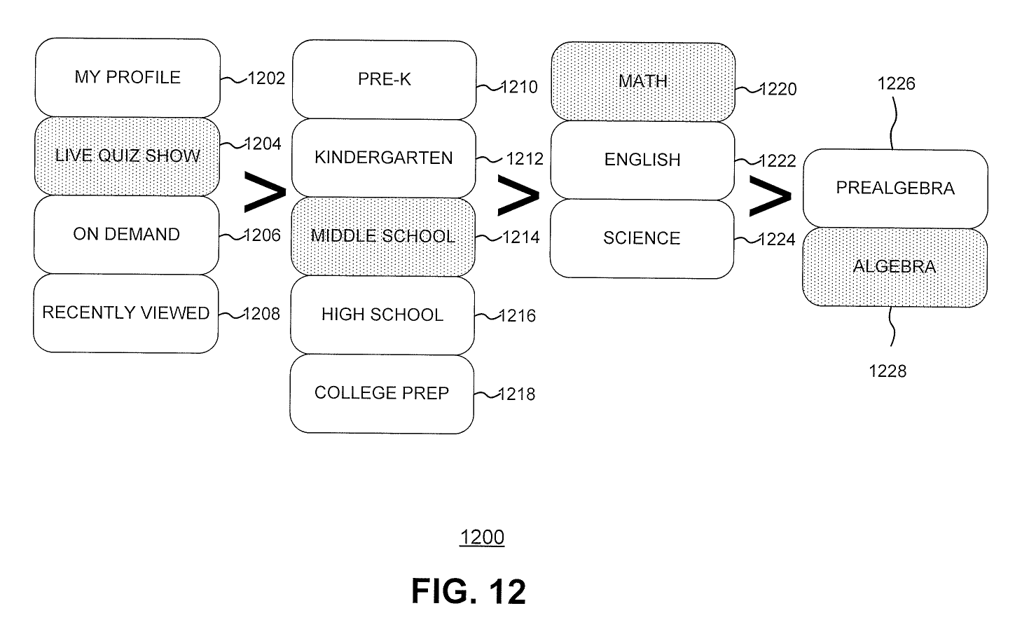

FIG. 12 is a block diagram of an exemplary GUI 1200 associated with selection of a quiz show. GUI 1200 may include four columns of buttons, e.g., four columns of menu options. The first column of menu options may include a MY PROFILE option 1202, a LIVE QUIZ SHOW option 1204, an ON DEMAND option 1206, and a RECENTLY VIEWED option 1208. In GUI 1200, the LIVE QUIZ SHOW option 1204 is highlighted and selected (as shown by the gray shading). The second column of menu options may include a PRE-K option 1210, KINDERGARTEN option 1212, MIDDLE SCHOOL option 1214, HIGH SCHOOL option 1216, and COLLEGE PREP option 1218. This second column of menu options may include the menu options associated with selecting the LIVE CLASSES option 1204 from the first column of menu options. In the exemplary display in FIG. 12, MIDDLE SCHOOL option 1214 may be highlighted and selected (as shown by the gray shading). The third column of menu options may include a MATH option 1220, an ENGLISH option 1222, and a SCIENCE option 1224. The third column of menu options may include the menu options associated with selecting MIDDLE SCHOOL option 1214 in the second column. In exemplary GUI 1200 of FIG. 12, MATH option 1212 is highlighted and selected (as shown by the gray shading). The fourth column of menu options may include a PRE ALGEBRA option 1226 and an ALGEBRA option 1228. In exemplary GUI 1200 of FIG. 12, ALGEBRA option 1228 may be highlighted and selected (as shown by the gray shading). A user (e.g., a student, parent, or teacher) may navigate GUI 1200, as described above, using remote 114 to join or watch an interactive quiz show, such as the interactive quiz show described above with respect to FIGS. 9 and 10.

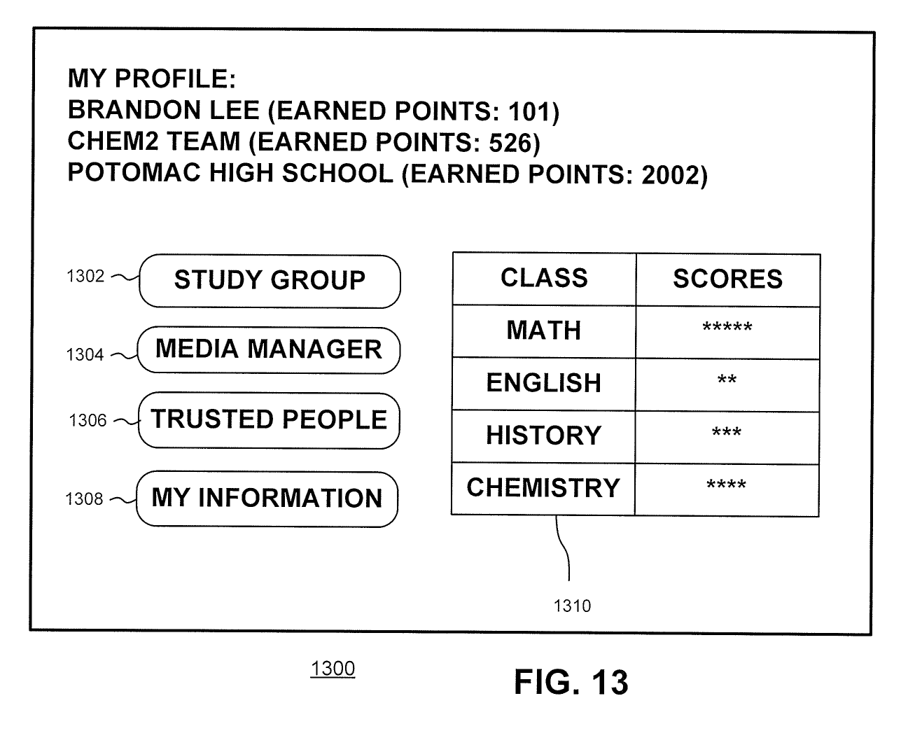

FIG. 13 is a block diagram of a GUI 1300 associated with an exemplary student profile. As illustrated in FIG. 13, exemplary GUI 1300 may be associated with a student named Brandon Lee of Potomac High School. GUI 1300 may include a STUDY GROUP option 1302, a MEDIA MANAGER option 1304, a TRUSTED PEOPLE option 1306, and a MY INFORMATION option 1308. A student may select MY INFORMATION option 1308 to access test scores, assignments due, assignment scores, grades, etc. A student may select STUDY GROUP option 1303 to communicate with and define other students for interaction. A student may select MEDIA MANAGER option 1304 to view movies, recorded classes, and television shows, and to listen to music, etc. A student may select TRUSTED PEOPLE option 1306 to define individuals that may access the student's information, such as parents, siblings, teachers, and other students. GUI 1300 may also include a brief display 1310 of the student's scores. GUI 1300 may also include the number of points accumulated by the student (for completing assignments and quizzes, etc.). GUI 1400 may also include the number of points accumulated by the school (e.g., for quiz shows). As shown in FIG. 13, Brandon Lee has accumulated 101 points, the CHEM2 TEAM earned 526 points, and POTOMAC HIGH earned 2002 points.

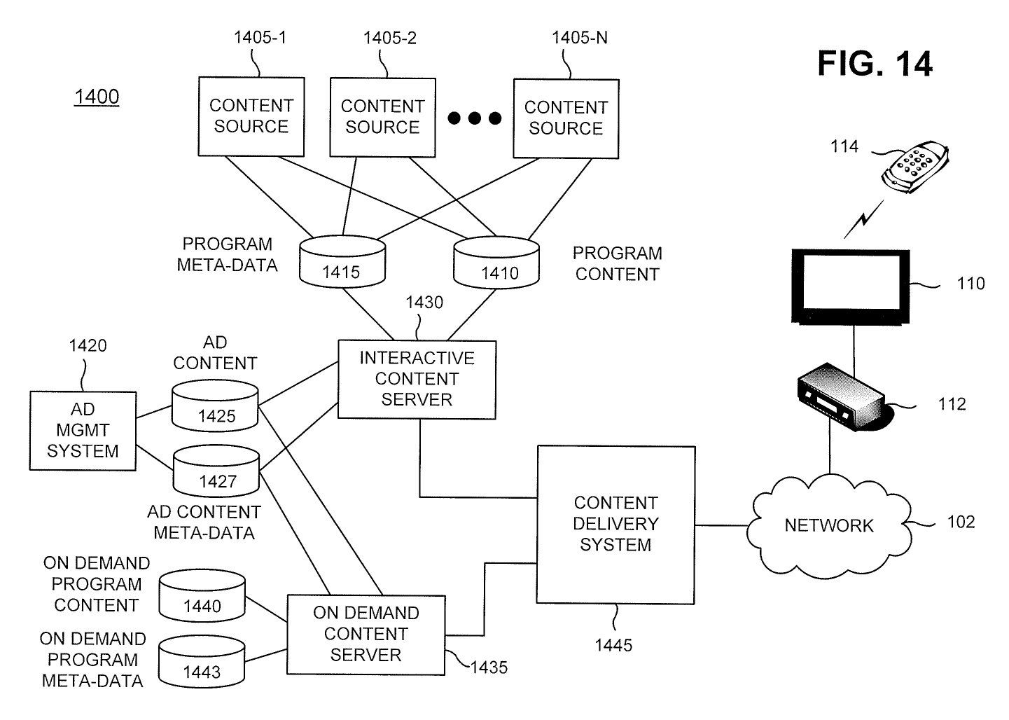

FIG. 14 is a block diagram of an alternative exemplary environment 1400 in which systems and methods described herein may be implemented. Environment 1400 may include content sources 1405-1, 1405-2, . . . , 1405-N (where N>=1) (collectively referred to as “content sources 1405”), a program content database 1410, a program meta-data database 1415, an advertising (ad) management (mgmt) system 1420, an advertising content database 1425, an advertising content meta-data database 1427, an interactive content server 1430, an on-demand content server 1435, an on-demand content database 1440, an on-demand meta-data database 1443, and a content delivery system 1445. Environment 1400 may also include network 102, STB 112, TV 110, and remote control 114 as shown in FIG. 1. In practice, environment 1400 may include more, fewer, or different devices than are shown in FIG. 14. Also, two or more of these devices may be implemented within a single device, or a single device may be implemented as multiple, distributed devices. Further, while FIG. 14 shows direct connections between the various devices, any of these connections can be indirectly made via a network, such as a local area network, a wide area network (e.g., the Internet), a telephone network (e.g., the Public Switched Telephone Network (PSTN) or a cellular network), or a combination of networks.

Content sources 1405 may include any type or form of content, including interactive or non-interactive content. For example, content sources 1405 may include free television broadcasts (e.g., local broadcasts, such as NBC, CBS, ABC, and Fox), for-pay television broadcasts (e.g., TNT, ESPN, HBO, Cinemax, CNN, etc.), and/or web-based content (e.g., streaming content from web sites). For example, content sources 1405 may include one or more studios and studio servers, such as studio 128 and studio server 130 of FIG. 1. Content sources 1405 may include one or more materials databases, such as materials database 126 of FIG. 1. Content sources 1405 may include one or more quiz databases, such as quiz database 118 of FIG. 1. Content sources 1405 may include one or more student profile databases, such as student profile database 124 of FIG. 1.

Program content database 1410 may store video signals representing the programs provided by various ones of content sources 1405. Program content database 1410 may store interactive or non-interactive content.

Program meta-data database 1415 may store meta-data associated with the programs provided by various ones of content sources 1405. Program meta-data database 1415 may store an association between content and advertisements with which the content corresponds. In one embodiment, program meta-data database 1415 may also store content icons and an association between the content icons and the programs and/or advertisements with which the content icons correspond. The meta-data might include program descriptions, program line-ups and/or schedules, or other information associated with the programs in program content database 1410. An example of meta-data may include information stored in quiz table 300, e.g., in an XML (eXtensible Markup Language)-based data file.

Advertising management system 1420 may control advertising content presented in connection with the programs in program content database 1410 and/or on-demand content database 1440. Advertising management system 1420 may store advertising content in advertising content database 1425. The advertising content may include advertisements (e.g., commercials that are inserted within a program signal, long form advertisements that are not inserted within the program signal, text or graphics that are overlaid on a program or an advertisement, advertisements that are presented alongside the program signal, and/or interactive advertisements) and/or links to advertisements that may be served via a network, such as the Internet. Advertising content meta-data database 1427 may store meta-data associated with the advertisements in advertising content database 1425. Meta-data stored in database 1427 may include, for example, scheduling information, rating information, category information, length of advertisement, classification information, expiration date of the advertisement, or other information that advertising management system 1420 and/or content servers 1430 and/or 1435 may find useful in serving and/or targeting the advertising content.

Interactive content server 1430 may include a device that is capable of controlling the serving of programs from program content database 1410, the program meta-data from program meta-data database 1415, and/or the advertising content from advertising content database 1425. Interactive content server 1430 may also serve non-interactive content from non-interactive content sources. In one embodiment, content server 1430 may include a content mixing engine to select information, such as programs, program meta-data, advertising content, and/or advertisement meta-data, and mix the information together. Interactive content server 1430 may also perform transcoding of the mixed information. Interactive content server 1430 may include a device that is capable of managing the serving of interactive content, such as live, interactive learning content. Interactive content server 1430 may retrieve content, as necessary, from program content database 1410.

On-demand program database 1440 may store on demand content. For example, previously recorded live, interactive learning content may become on-demand content after a showing and may be stored in on-demand program content database 1440. In one embodiment, on-demand program database 1440 may include one or more materials databases, such as materials database 126 of FIG. 1. On-demand program database 1440 may include one or more quiz databases, such as quiz database 118 of FIG. 1. On-demand program database 1440 may include one or more student profile databases, such as student profile database 124 of FIG. 1.

On-demand meta-data database 1443 may store meta-data associated with the programs stored in on-demand program database 1440. On-demand program meta-data database 1443 may store an association between content and advertisements with which the content corresponds. In one embodiment, on-demand program meta-data database 1443 may also store content icons and an association between the content icons and the programs and/or advertisements with which the content icons correspond. The meta-data might include program descriptions, program line-ups and/or schedules, or other information associated with the programs in on-demand program content database 1440. An example of meta-data may include information stored in quiz table 300, e.g., in an XML-based data file.

On-demand content server 1435 may retrieve on-demand content, as necessary, from on-demand content database 1440. On-demand content server 1435 may include a device that is capable of controlling the serving of programs from on-demand program content database 1440, meta-data from on-demand meta-data database 1443, meta-data from ad content meta-data database 1427, and/or advertising content from advertising content database 1425. In one embodiment, content server 1430 may include a content mixing engine to select information, such as programs, program meta-data, advertising content, and/or advertisement meta-data, and mix the information together. Content server 1435 may also perform transcoding of the mixed information.

Content delivery system 1445 may include a device that is capable of delivering information to a customer's equipment (e.g., STB 112, TV 110, etc.). Content delivery system 1445 may include a service adapter component and a media relay component. The service adapter component may control what information (e.g., what programs and/or advertisements) to provide to which customers based, for example, on customer subscriptions and/or profiles, groups, etc. (e.g., user table 400, achievement table 500, and/or quiz table 300). The media relay component may control the transmission of the information to the customers. The media relay component may perform encoding and/or encryption functions. Content delivery system 1445 may also include one or more on demand components that may provide on demand services (e.g., music, video, and/or games on demand).

This patent application hereby incorporates herein by reference the following patent applications, filed on the same day as the present application: (1) INTERACTIVE LEARNING, Attorney Docket No. 20070262; (2) INTERACTIVE LEARNING, Attorney Docket No. 20070263; and (3) INTERACTIVE LEARNING, Attorney Docket No. 20070213.

Interactive learning may be a better learning environment for students when compared to passive television viewing or other non-learning activities. In one or more embodiments described above, students may communicate and collaborate with their teachers, peers, and parents in a learning environment. One or more embodiments disclosed above may allow for students to participate in an interactive quiz show individually or as part of a team. A high-speed, symmetric, fiber-optic network may provide for some or all of the structure to implement systems and methods described herein.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While series of blocks have been described above, such as in FIGS. 7 and 10, the order of the blocks may differ in other implementations. Moreover, non-dependent acts may be performed in parallel.

It will be apparent that aspects of the embodiments, as described above, may be implemented in many different forms of software, firmware, and hardware in the implementations illustrated in the figures. The actual software code or specialized control hardware used to implement these embodiments is not limiting of the invention. Thus, the operation and behavior of the embodiments of the invention were described without reference to the specific software code—it being understood that software and control hardware may be designed to the embodiments based on the description herein.

Further, certain portions of the invention may be implemented as “logic” that performs one or more functions. This logic may include hardware, such as an application specific integrated circuit, a field programmable gate array, a processor, or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
selecting, by a computer, one or more students for receiving a quiz question;
identifying, by a computer, test scores stored in a database and associated with the one or more students;
selecting, by the computer, a quiz question from a plurality of quiz questions based on the identified test scores;
sending the selected quiz question through a network to the one or more students;
receiving, through the network, an answer to the quiz question from the one or more students; and
adding points, after receiving the answer from the one or more student, to an account associated with the one or more students.

2. The method of claim 1, further comprising:
determining, by the computer, an accuracy of the answer to the quiz question,
where adding points to the account associated with the student depends on the accuracy of the answer determined by the computer.

3. The method of claim 2, where adding points includes adding points to an account associated with a team associated with the one or more students.

4. The method of claim 2, further comprising:
displaying the quiz question on a display; and
receiving the answer to the quiz question via a remote control associated with the display.

5. The method of claim 4, where the one or more students includes a plurality of students and where the plurality of students are geographically diverse.

6. The method of claim 5, where a first of the plurality of students is associated with a first team and a second of the plurality of students is associated with a second team.

7. The method of claim 6, where receiving an answer includes receiving a first answer from the first of the plurality of students and receiving a second answer from the second of the plurality of students, the method comprising:
determining whether the first answer or second answer was received first;
where adding points to the account associated with the team includes adding points to a first account associated with the first team or adding points to a second account associated with the second team based on the determination of whether the first answer or the second answer was received first.

8. A system comprising:
a database to store test scores associated with a plurality of students;
a processor to:
select one or more students of the plurality of students to receive a quiz question;
identify the test scores associated with the one or more students; and
select a quiz question from a plurality of quiz questions based on the identified test scores; and
a transceiver to send the selected quiz question through a network to the one or more students and receive, through the network, an answer to the quiz question from the one or more students,
where the processor adds points, after receiving the answer from the one or more students, to an account associated with the one or more students.

9. The system of claim 8, where the processor determines the accuracy of the answer to the quiz question, and adds points to the account associated with the student depends on the accuracy of the answer determined by the computer.

10. The system of claim 9, where the processor adds points to an account associated with a team associated with the one or more students.

11. The system of claim 9, further comprising:
a display to display the quiz question; and
a remote control associated with the display to receive the answer to the quiz question.

12. The system of claim 11, where the one or more students includes a plurality of students and where the plurality of students are geographically diverse.

13. The system of claim 11, where the database associates a first of a plurality of students with a first team and associates a second of the plurality of students with a second team.

14. The system of claim 13, where the transceiver receives a first answer from the first of the plurality of students and receives a second answer from the second of the plurality of students,
where the processor determines whether the first answer or second answer was received first;
where the processor adds points to a first account associated with the first team or adds points to a second account associated with the second team based on the determination of whether the first answer or second answer was received first.

15. A computer-readable medium including instructions executable by at least one processor, the computer readable medium comprising:
one or more instructions for selecting one or more students for receiving a quiz question;
one or more instructions for identifying test scores stored in a database and associated with the one or more students;
one or more instructions for selecting a quiz question from a plurality of quiz questions based on the identified test scores;
one or more instructions for sending the selected quiz question through a network to the one or more students;
one or more instructions for receiving, through the network, an answer to the quiz question from the one or more students; and
one or more instructions for adding points, after receiving the answer from the one or more student, to an account associated with the one or more students.

16. The computer-readable medium of claim 15, further comprising:
one or more instructions for determining the accuracy of the answer to the quiz question,
where adding points to the account associated with the student depends on the accuracy of the answer determined by the computer.

17. The computer-readable medium of claim 16, further comprising one or more instructions for adding points to an account associated with a team associated with the one or more students.

18. The computer-readable medium of claim 16, further comprising:
one or more instructions for displaying the quiz question on a display; and
one or more instructions for receiving the answer to the quiz question via a remote control associated with the display.

19. The computer-readable medium of claim 18, further comprising:
one or more instructions for sending the quiz question to a plurality of geographically diverse students.

20. The computer-readable medium of claim 18, further comprising:
one or more instructions for sending, through a network, the quiz question to a first of a plurality of students associated with a first team and a second of a plurality of students associated with a second team.

21. The computer-readable medium of claim 20, further comprising
one or more instructions for receiving a first answer from the first of the plurality of students and;
one or more instructions for receiving a second answer from a second plurality of students, the method comprising:
one or more instructions for determining whether the first answer or second answer was received first;
one or more instructions for adding points to a first account associated with the first team or adding points to a second account associated with the second team based on the determination whether the first answer or second answer was received first.
